(19) United States
(12) Patent Application Publication
(10) Pub. No.: US 2013/0075201 A1
(43) Pub. Date: Mar. 28, 2013

(54) ELEVATOR CONTROL APPARATUS AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/328,088

(22) Filed: Dec. 16, 2011

(30) Foreign Application Priority Data
Sep. 27, 2011 (TW) 100134899

(51) Int. Cl. B66B 13/14

(52) U.S. Cl. 187/316

(57) ABSTRACT

A control method is used for an elevator. The elevator includes an enclosure located at each floor, two doors mounted to the enclosure, and a control unit to control the doors to open or close. The control method includes, capturing an image of a scene in front of the doors by a camera. Checking the image to determine whether there are people in front of the doors, and outputting a first control signal to the control unit to stop closing the doors upon the condition that there is a person in front of the doors.

### BACKGROUND

1. Technical Field

The present disclosure relates to an apparatus for controlling elevators and a control method of the apparatus.

2. Description of Related Art

When someone tries to enter an elevator when the doors are closing, the someone may be hit by the closing doors. This could result in injury to that someone. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of a control apparatus.

FIG. 2 is a schematic view of an elevator.

FIG. 3 is a block diagram of the elevator.

FIGS. 4 and 5 are schematic views showing the control apparatus of FIG. 1 attached to the elevator of FIG. 2.

FIG. 6 is a flowchart of an exemplary embodiment of a control method.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

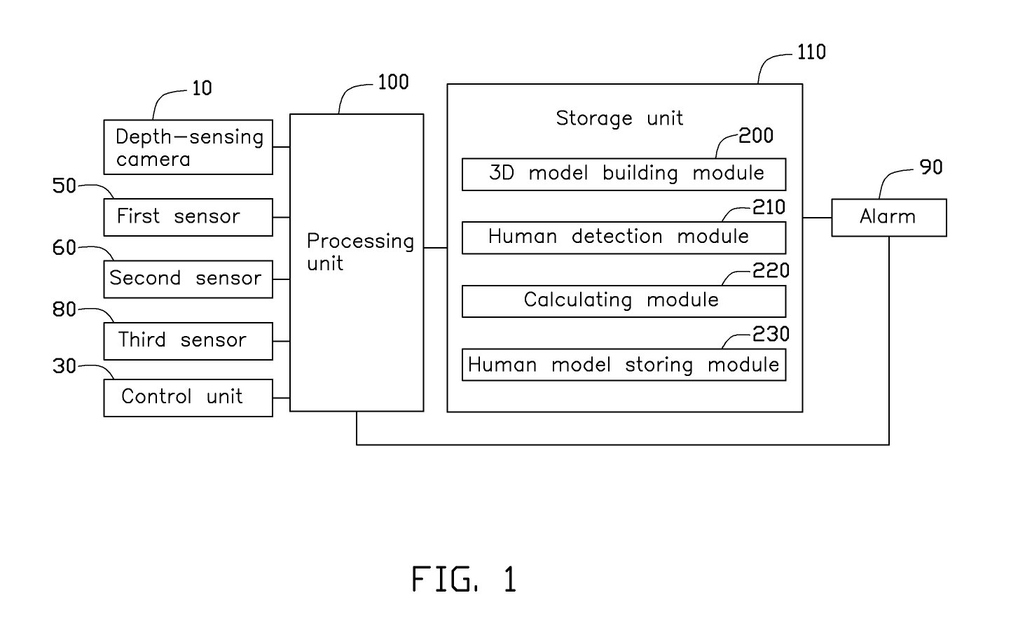

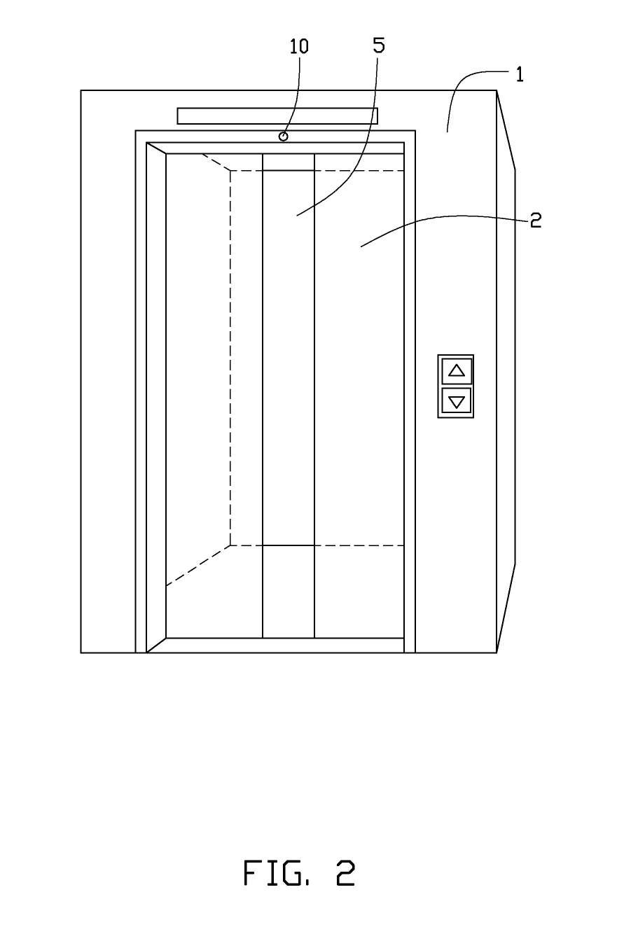

Referring to FIG. 1, an exemplary embodiment of a control apparatus is used for an elevator 5 (see FIG. 2). The apparatus includes a plurality of depth-sensing cameras 10, a processing unit 100, a storage unit 110, a plurality of first sensors 50 (for clarity only one is shown), a plurality of second sensors 60 (for clarity only one is shown), a third sensor 80, and a plurality of alarms 90 (for clarity only one is shown). The storage unit 110 includes a three dimensional (3D) model building module 200, a human detection module 210, a calculating module 220, and a human model storing module 230, which may include computer code to be executed by the processing unit 100.

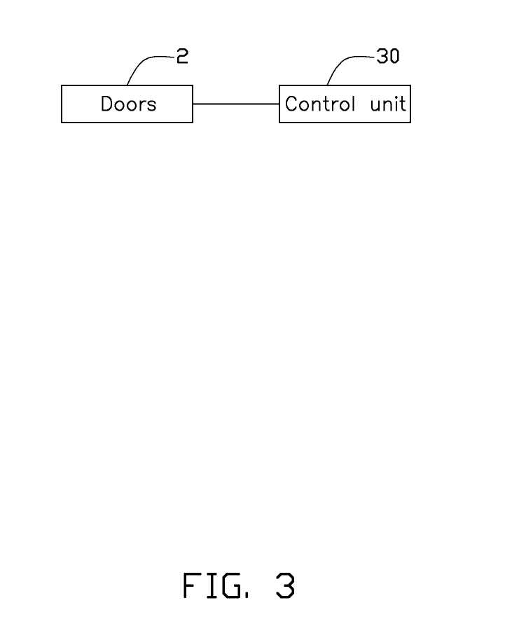

Referring to FIGS. 2 and 3, the elevator includes a plurality of enclosures 1, a plurality of doors 2, and a control unit 30. When the elevator 5 stops at a floor, there are two doors 2, a depth-sensing camera 10, a first sensor 50, a second sensor 60, and an alarm 90 for each enclosure 1 located at the floor. Inner spaces of the enclosures 1 of all the floors communicate, so the elevator 5 can move up and down. The control unit 30 opens or closes the doors 2.

Each depth-sensing camera 10 is mounted on a corresponding enclosure 1 above the corresponding doors 2, to capture an image of a scene in front of the doors 2, and gather distance data between a plurality of points and the depth-sensing camera 10 in the scene. In the embodiment, the depth-sensing camera 10 is a time-of-flight (TOF) camera. The TOF camera is a camera system that creates distance data between a plurality of points in the scene and the TOF camera. When the TOF camera shoots the scene, the TOF camera sends radio frequency (RF) signals. The RF signals are reflected back to the TOF camera when the RF signals meet an object in the scene. As a result, the distance data can be obtained according to time differences between sending and receiving the RF signals of the TOF camera.

The human model storing module 230 stores a number of models for different shapes of people. The depth-sensing cameras 10 may obtain the different models in advance.

The 3D model building module 200 builds a 3D model of the scene in front of the doors 2 according to the image captured by the depth-sensing camera 10 and the data about distances between a plurality of points in the scene and the depth-sensing camera. In the embodiment, according to the data regarding distances between a plurality of points in the scene and the depth-sensing camera 10, the plurality of points in the scene has coordinates relative to the depth-sensing camera 10. The 3D model building module 200 can obtain a 3D mathematical model according to the coordinates of the plurality of points and the image. The 3D mathematical model can be regarded as the 3D model of the scene in front of the doors 2.

The human detection module 210 checks the 3D model obtained by the 3D model building module 200 to determine whether there is a person in front of the doors 2. The human detection module 210 analyzes the 3D models using well known human recognition technology. In the embodiment, the human detection module 210 compares the 3D model obtained by the 3D model building module 200 with the different human models stored in the human model storing module 230 to determine whether there is a person in front of the doors 2. If a portion of the 3D model obtained by the 3D model building module 200 is similar to a human model stored in the human model storing module 230, a determination is made that there is a person in the 3D model, namely, there is a person in front of the doors 2. If the 3D model obtained by the 3D model building module 200 is different from all human models stored in the human model storing module 230, a determination is made that there are no people in the 3D model, namely, there are no people in front of the doors 2.

When there is a person in front of the doors 2, a determination is made that the closing doors 2 would hurt the person. In the embodiment, the depth of field of the depth-sensing camera 10 is small. As a result, when there is a person in the scene, a determination is made that the person is close to the doors 2.

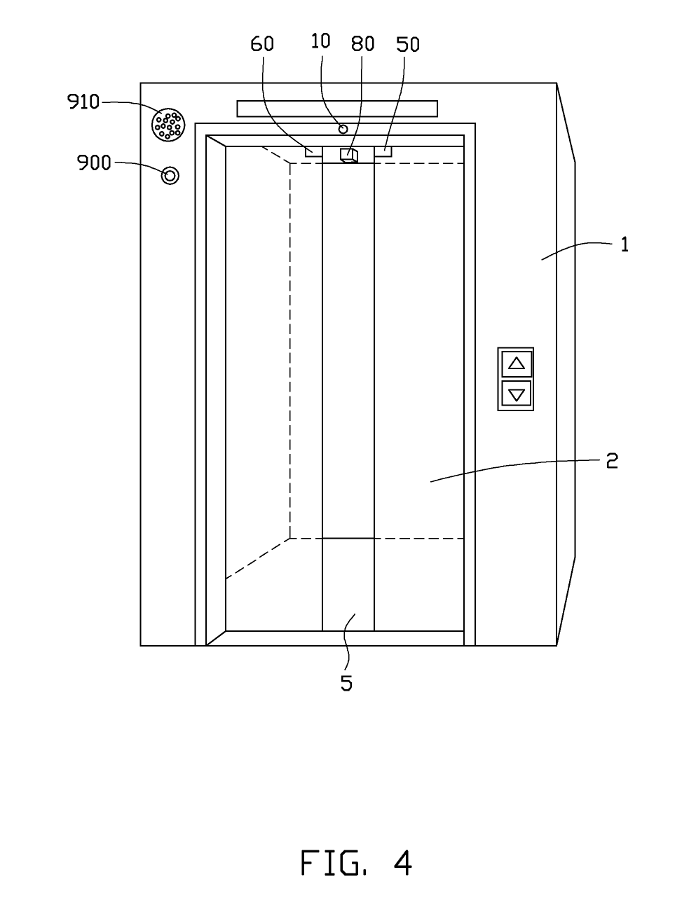

The calculating module 220 outputs a control signal to the control unit 30 and the corresponding alarm 90 when there is a person in front of the doors 2. The control unit 30 opens the doors 2 and the alarm 90 activates according to the control signal. In the embodiment, the alarm 90 includes a light 900 and a buzzer 910 mounted on the enclosure 1 (as shown in FIG. 4).

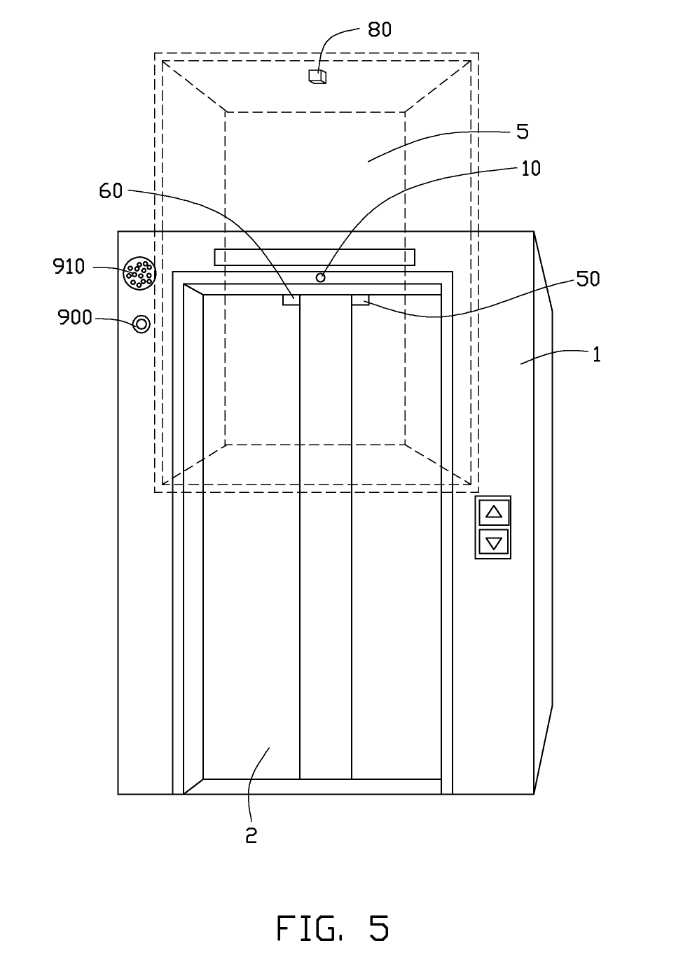

Referring to FIGS. 4 and 5, each first sensor 50 is mounted on a top edge of a first door 2 adjacent to a second door 2. The second sensor 60 is mounted on a top edge of the second door 2 adjacent to the first door 2. The third sensor 80 is mounted on a ceiling of the elevator 5. The first sensor 50, the second sensor 60, and the third sensor 80 are connected to the processing module 100. The calculating module 220 determines whether the first sensor 50, the second sensor 60, and the third sensor 80 are at a same horizontal level. If the three sensors 50, 60, and 80 are not at the same horizontal level, a determination is made that the elevator 5 does not stop at the floor corresponding to the doors 2. The calculating module 220 further determines whether the first sensor 50 contacts with the second sensor 60. If the first sensor 50 does not contact with the second sensor 60, a determination is made that the doors 2 are not closed, at this time, the light 900 lights. In addition, if there is a person in front of the doors 2, the calculating module 220 outputs the control signal to activate the buzzer 910.

If the three sensors 50, 60, and 80 are at the same horizontal level, a determination is made that the elevator 5 stops at the floor corresponding to the doors 2. In addition, if the doors are open, and there is a person in front of the doors 2, the calculating module 220 outputs the control signal to the control unit 30 to stop closing the doors 2.

In other embodiments, the depth-sensing camera 10 can be replaced by an ordinary camera. In addition, the 3D model building module 200 can be canceled. The camera captures an image in front of the doors 2. The human detection module 210 checks the image to determine whether there is a person in the image. The human model storing module 230 stores a plurality of images of different people.

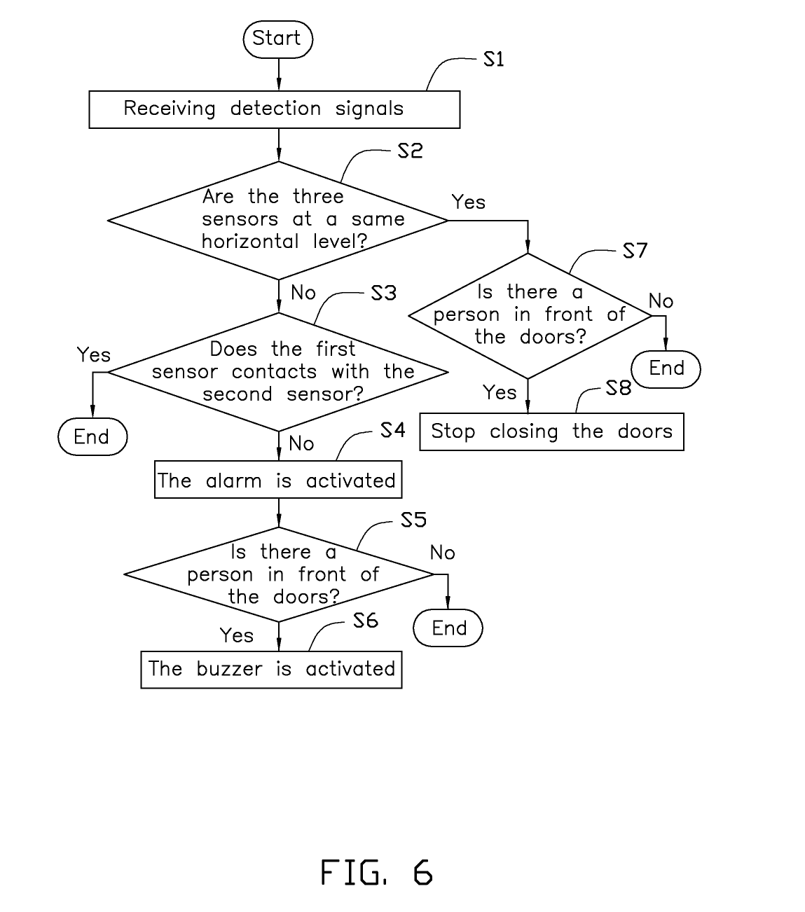

Referring to FIG. 6, an exemplary embodiment of a controlling method for an elevator includes the following steps.

In step S1, the calculating module 220 receives detection signals from the first sensor 50, the second sensor 60, and the third sensor 80.

In step S2, the calculating module 220 determines whether the first sensor 50, the second sensor 60, and the third sensor 80 are at a same horizontal level according to the detection signals. If the first sensor 50, the second sensor 60, and the third sensor 80 are not at the same horizontal level, step S3 is performed. If the first sensor 50, the second sensor 60, and the third sensor 80 are at the same horizontal level, step S7 is performed.

In step S3, the calculating module 220 further determines whether the first sensor 50 contacts with the second sensor 60. If the first sensor 50 does not contact with the second sensor 60, step S4 is performed. If the first sensor 50 contacts with the second sensor 60, the process ends.

In step S4, the calculating module 220 outputs the control signal to the light 900 to activate the light 900.

In step S5, the human detecting module 210 checks the 3D model obtained by the 3D model building module 200 to determine whether there is a person in front of the doors 2. If there is a person in front of the doors 2, step S6 is performed. If there are no people in front of the doors 2, the process ends.

In step S6, the calculating module 220 outputs the control signal to the buzzer 910 to activate the buzzer 910.

In step S7, the human detection module 210 checks the 3D model obtained by the 3D model building module 200 to determine whether there is a person in front of the doors 2. If there is a person in front of the doors 2, step S8 is performed. If there are no people in front of the doors 2, the process ends.

In step S8, the calculating module 220 outputs the control signal to the control unit 30 to stop closing the doors 2.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A control apparatus for an elevator, the elevator comprising an enclosure located at each floor, two doors mounted to the enclosure, and a control unit to control the doors to open or close, the control apparatus comprising:
a depth-sensing camera mounted on the enclosure above the doors, to capture an image of a scene in front of the doors and obtain data about distances between a plurality of points in the scene and the depth-sensing camera;
a processing unit connected to the depth-sensing camera; and
a storage unit connected to the processing unit and storing a plurality of programs to be executed by the processing unit, wherein the storage unit comprises:
a three dimension (3D) model building module to build a 3D model of the scene according to the image of the scene and the data about distances between the plurality of points in the scene and the depth-sensing camera;
a human detection module to check the 3D model to determine whether there is a person in front of the doors; and
a calculating module to output a first control signal to the control unit to stop closing the doors upon the condition that there is a person in front of the doors.

2. The control apparatus of claim 1, further comprising:
a first sensor mounted on a top edge of a first door adjacent to a second door;
a second sensor mounted on a top edge of the second door adjacent to the first door;
a third sensor mounted on a ceiling of the elevator; and
an alarm;
wherein the calculating module further determines whether the first sensor, the second sensor, and the third sensor are at a same horizontal level, upon the condition that the first to third sensors are at the same horizontal level, the calculating module further determines whether the first sensor contacts with the second sensor, upon the condition that the first sensor does not contact with the second sensor and there is a person in front of the doors, the calculating module outputs a second control signal to activate the alarm.

3. The control apparatus of claim 1, wherein the depth-sensing camera is a time-of-flight camera.

4. A control apparatus for an elevator, wherein the elevator comprises an enclosure located at each floor, two doors mounted to the enclosure, and a control unit controlling the doors to open or close, the control apparatus comprising:
a camera mounted on the enclosure, to capture an image of a scene in front of the doors;
a processing unit connected to the camera; and
a storage unit connected to the processing unit and storing a plurality of programs to be executed by the processing unit, wherein the storage unit comprises:
a human detection module to check the image to determine whether there is a person in front of the doors; and
a calculating module to output a first control signal to the control unit to stop closing the doors upon the condition that there is a person in front of the doors.

5. The control apparatus of claim 4, further comprising:
a first sensor mounted on a top edge of a first door adjacent to a second door;
a second sensor mounted on a top edge of the second door adjacent to the first door;
a third sensor mounted on a ceiling of the elevator; and
an alarm;
wherein the calculating module further determines whether the first sensor, the second sensor, and the third sensor are at a same horizontal level, upon the condition that the first to third sensors are at the same horizontal level, the calculating module further determines whether the first sensor contacts with the second sensor, upon the condition that the first sensor does not contact with the second sensor and there is a person in front of the doors, the calculating module outputs a second control signal to activate the alarm.

6. A control method for an elevator, the elevator comprising an enclosure located at each floor, two doors mounted to the enclosure, and a control unit to control the doors to open or close, the control method comprising:
capturing an image of a scene in front of the doors and obtaining data about distances between a plurality of points in the scene and a depth-sensing camera;
building a three dimension (3D) model of the scene according to the image of the scene and the data about distances between the plurality of points in the scene and the depth-sensing camera;
checking the 3D model to determine whether there is a person in front of the doors; and
outputting a first control signal to the control unit to stop closing the doors upon the condition that there is a person in front of the doors.

7. The control method of claim 6, further comprising:
arranging a first sensor on a top edge of a first door adjacent to a second door, a second sensor on a top edge of the second door adjacent to the first door, and a third sensor on a ceiling of the elevator;
determining whether the first to third sensors are at a same horizontal level;
determining whether the first sensor contacts with the second sensor upon the condition that the first to third sensors are at the same horizontal level;
checking the 3D model to determine whether there is a person in front of the doors upon the condition that the first sensor does not contact with the second sensor; and
outputting a second control signal to activate an alarm upon the condition that there is a person in front of the doors.

8. The control method of claim 7, wherein the depth-sensing camera is a time-of-flight camera.
